(19) United States
(12) Patent Application Publication
(10) Pub. No.: US 2007/0230734 A1
(43) Pub. Date: Oct. 4, 2007

(54) Monitor Transducer System and Manufacturing Method Thereof

(75) Inventor: John Beard, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 11/696,421

(22) Filed: Apr. 4, 2007

Related U.S. Application Data
(60) Provisional application No. 60/744,229, filed on Apr. 4, 2006.

(51) Int. Cl. H04R 9/08; H04R 11/04; H04R 21/02; H04R 3/00

(52) U.S. Cl. 381/361; 381/355; 381/91; 381/122

(57) ABSTRACT

A microphone assembly comprises a housing having a top housing and a bottom housing fixed attached together, defining a volume. The microphone assembly further comprises a motor assembly and a circuit assembly disposed within the housing. The motor assembly includes a backplate and a diaphragm. The motor assembly further comprises a first end and a second end spaced apart by a central portion wherein a portion of the first and second ends fixedly attached to the inner surface of the top housing or the bottom housing. The circuit assembly includes a connecting lead for making contact with the diaphragm or a backplate. The circuit assembly is arranged in series with the motor assembly, but not stacked over or under the motor assembly.

### CROSS-REFERENCE TO RELATED APPLICATION

This patent claims benefit under 35 U.S.C. § 119 (e) to United States Provisional Application No. 60/744,229, filed Apr. 4, 2006 and entitled Monitor Transducer System and Manufacturing Method Thereof, the disclosure of which is hereby incorporated herein for all purposes.

### BACKGROUND

Transducers such as microphones, receivers and speakers are useful in many listening devices such as hearing aids, earphones, in-ear monitors, headphones, Bluetooth wireless headsets, or the like. For instance, a listening device, such as an in-ear monitor that completely fills the outer portion of the ear canal, includes a bulky input converter, i.e. a microphone, an amplification portion, and a receiver. An input signal is received by the input converter and converted to an electrical input signal. Such signals are fed to the amplification portion for further processing and amplification before transmission to the receiver. The receiver being configured to receive the processed signals converts the signals into acoustic signals for transmission to the wearer.

One typical microphone uses an electret portion (a diaphragm and a backplate) and an electronic processing system that are contained within a housing. The overall height of the microphone, i.e., the height of the housing is defined by the configuration of the electret portion and the electronic processing system. Based on the usual manner of assembly of the microphone, the electret portion is placed either over or under the electronic processing system. Conventionally, the casing for the working components is rectangular in shape. When the microphone engages the inner wall of the ear canal, it causes considerable discomfort when worn by the user, due to the shape of the case.

For the reasons stated above, and for other reasons stated below which will become apparent to those skilled in the art upon reading and understanding the present specification, there is a significant need in the art for an improved transducer monitor system to overcome these problems.

### BRIEF DESCRIPTION OF THE DRAWINGS

For a more complete understanding of the disclosure, reference should be made to the following detailed description and accompanying drawings wherein:

FIG. 1 is a block diagram of a listening device according to various embodiments of the present invention;

FIG. 2 is a perspective view of a transducer monitor system, in accordance with various embodiments of the present invention;

FIG. 3 is a perspective view of the transducer monitor system and a tubing assembly, in accordance with various embodiments of the present invention;

FIG. 4 is an exploded view of a thin microphone unit in accordance with various embodiments of the present invention;

FIG. 5 is a cross-sectional view of the thin microphone unit of FIG. 4; and

FIG. 6 is a cross-sectional view of another embodiment of a thin microphone unit, in accordance with various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents failing within the spirit and scope of the invention defined by the appended claims.

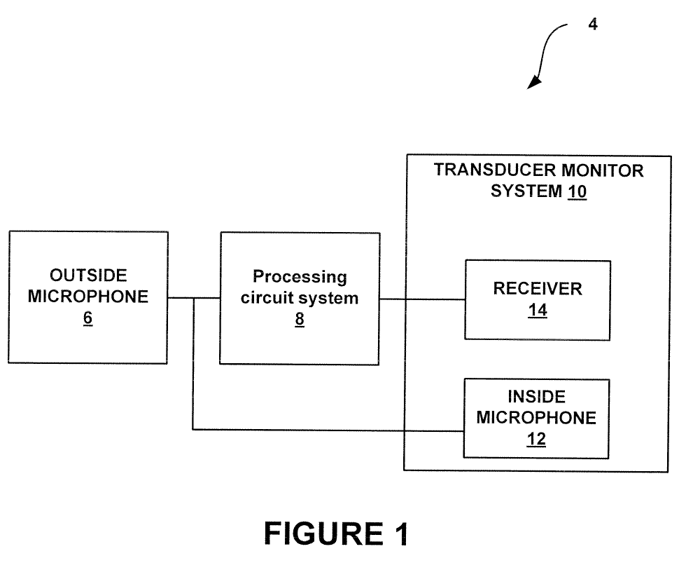

FIG. 1 is a block diagram of a listening device 4, such as hearing aids, in-ear monitors, electronic hearing protection devices, Bluetooth wireless headsets, earphones, and the like. The listening device 4 may also be virtually any type of audio and listening device. The listening device 4 includes an outside microphone 6, a processing circuit system 8, and a transducer monitor system 10. The outside microphone 6 receives acoustic energy from an acoustic environment external to the wearer of the listening device and converts the sound into corresponding electrical signals that are, in turn, provided to the processing circuit system 8. While FIG. 1 shows one microphone, microphone 6 may include one or more microphone transducers without departing the scope of the invention.

The transducer monitor system 10 includes an inside microphone 12 and a receiver 14. A sound pressure level (SPL), i.e. occlusion effect, within the ear canal entering the inside microphone 12 is converted to an electrical signal that is, in turn, transmitted to the processing circuit system 8. The processing circuit system 8, such as a digital processing system, a sound measurement system, a filter system, a control signal system, a converter, a sound pressure level adjusting system, or combination thereof, receives the signals from the outside and inside microphones 6, 12 and then processes the signals before transmission to the receiver 14. The receiver 14 converts the processed signals provided b the processing circuit system 8 to a sound signal for transmission to the user. While FIG. 1 shows one receiver, the receiver 14 may include one or more receiver transducers each of which are coupled to the microphone 12 without departing the scope of the invention. The receiver 14 may be a silicon (micro-electromechanical machined, MEMS) receiver, a balanced armature receiver, or a moving coil receiver, depending on the desired applications. Other types of receiver are possible. The microphone 6, 12 may be a silicon (micro-electromechanical machined, MEMS) condenser microphone, an electret microphone, an omni-directional microphone, a directional microphone, or a dynamic microphone, depending on the desired applications. The microphones 6, 12 may be virtually any type of microphone.

Depending on the type of microphone, the microphones 6, 12 may include a motor assembly (not shown) and a circuit assembly (not shown) arranged in series with the motor assembly, but not stacked over or under the motor assembly. The formation of the motor assembly and the circuit assembly will follow.

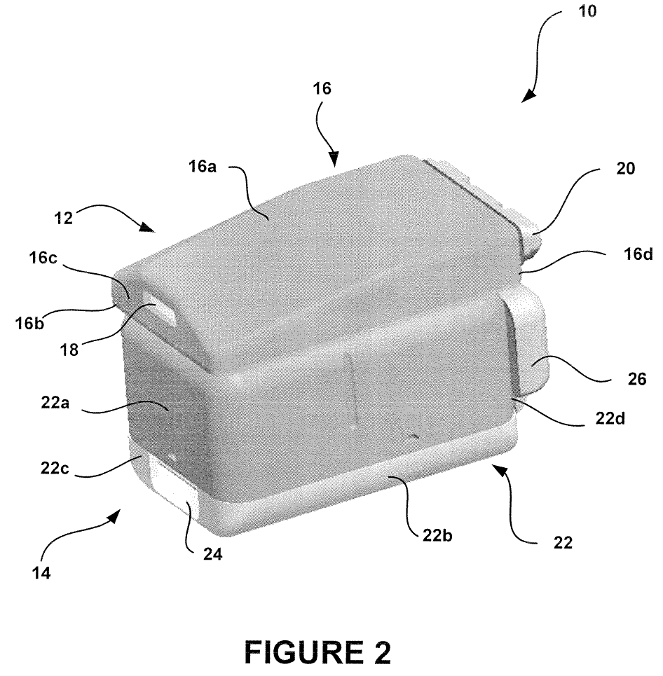

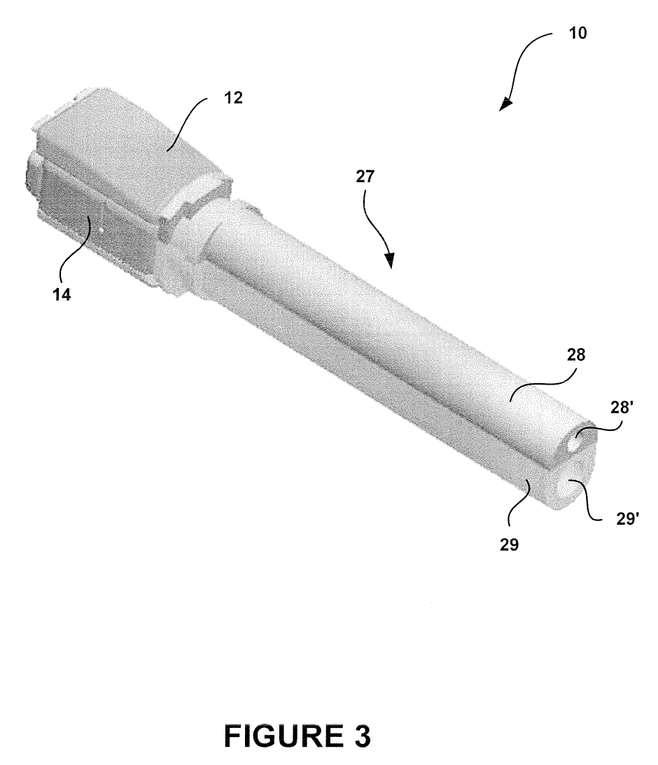

FIGS. 2-3 illustrate an embodiment of the transducer monitor system 10. The system 10 processes audio signals from an external environment for communication to the wearer and further provides for monitoring the SPL inside the ear canal. To do so, the system 10 may include the inside microphone 12 and the receiver 14. The microphone 12 may be mounted to the receiver 14 and such mounting may be achieved by any conventional method of attachment. In this regard, the microphone 12 and the receiver 14 may form a conjoined microphone-receiver assembly as depicted in FIG. 2. However, such mounting is not required or essential to the invention, and the microphone 12 may exist within the system 10 separately from the receiver 14. The microphone 12 may include a tapered housing 16, an external terminal 20 and a sound port 18. The housing 16 as shown includes a cover 16a and a base 16b attached to the cover 16a by any conventional method of attachments to retain the working components (e.g., a circuit assembly and a motor assembly as is well known). As shown in FIG. 2, the housing 16 is tapered near the sound port 18 to provide better fitting into the ear canal and/or the listening device incorporating the system 10 and further to accommodate the working components which will be discussed later. The external terminal 20 couples to the processing circuit system (See FIG. 1) and may be mounted to a rear portion 16d of the housing 16. The sound port 18 may be provided at a front portion 16c of the housing 16, or at any convenient and operable location on the housing 16. The microphone 12 senses acoustic signals within the ear canal representing a SPL in the ear canal. The microphone 12 converts these acoustic signals to electrical signals that may be processed by the processing circuit system (See FIG. 1) along with other signals before the signal is transmitted to the receiver 14.

The receiver 14 may include a housing 22, an external terminal 26, and a sound port 24. The housing 22 includes a cover 22a and a base 22b attached to the cover 22a by any conventional method of attachments to retain the working components (e.g., an acoustic assembly, a motor assembly, and a coupling assembly as is well known). The external terminal 26 coupled to the processing circuit system (See FIG. 1) may be mounted to a rear portion 22d of the housing 22 and the sound port 24 may be provided at a front portion 22c of the housing 22. Of course the terminal 26 and the sound port 24 may be provided at any convenient and operable location on the housing 22. The receiver 14 is operable upon the processed signals received from the processing circuit system (See FIG. 1) to generate acoustic signals that are then transmitted to the ear canal through the sound port 24 of the receiver 14. In alternative arrangements, the external terminals 20, 26 of the microphone 12 and the receiver 14 may be combined into one terminal to minimize the number of electrical connections. As shown in FIG. 3, an optional tubing member 27 is coupled to the transducer monitor system 10. A first tube portion 28 may mount to the microphone 12 and a second tube portion 29 may mount to the receiver 14. As depicted in FIG. 3, the first and second tubing members may be a single, duel lumen structure or tubing member 27 having separate passageways 28′ and 29′. Alternatively, individual tube structures may be used. Each passageway 28′, 29′ is suitably aligned with the respective sound ports 18, 24 of the microphone 12 and the receiver 14. It will be understood that the length of the tube(s) may vary without departing the scope of the invention.

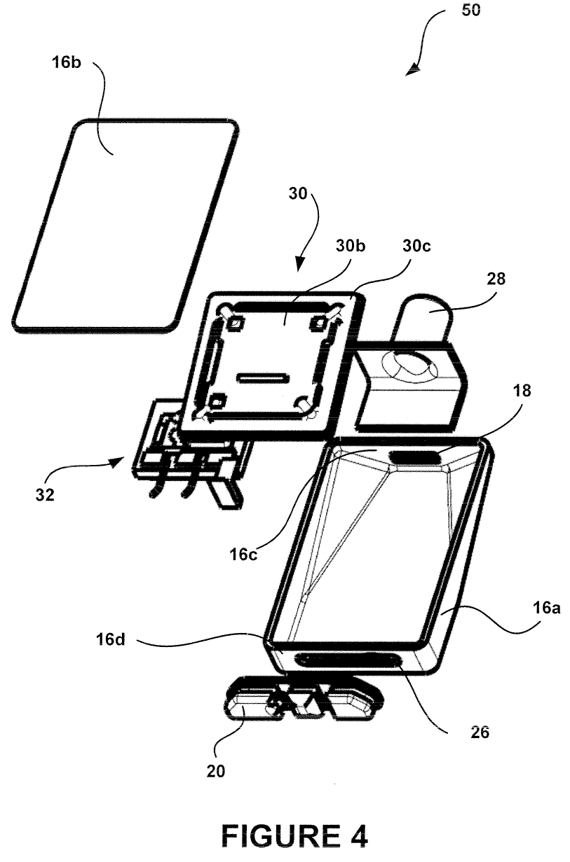

FIG. 4 illustrates an exploded view of a microphone 50. The microphone 50 includes a motor assembly 30, also known as electret portion and a circuit assembly 32. The motor assembly 30 includes a diaphragm (not shown), a backplate 30b, and a frame 30c sandwiched between the diaphragm (not shown) and the backplate 30b. It will be understood that the operation of the microphone 50 is generally based on the change in capacitance and resulting electric signal that may be generated as a result of movement of the diaphragm (not shown) responsive to exposure to sound pressure relative to the fixed electrode of the backplate 30b. The sound pressure may be the result of acoustic energy presented in front of the ear canal, or from other sources. The circuit assembly 32 is electrically coupled to the motor assembly 30 via a connecting lead 38. The circuit assembly 32 may include a preamplifier such as, for example, a source-follower field effect transistor (FET) integrated circuit, or any suitable signal processing and amplification circuit. The microphone 50 may be an inside microphone 12 (See FIG. 1), an outside microphone 4 (See FIG. 2), or combination thereof.

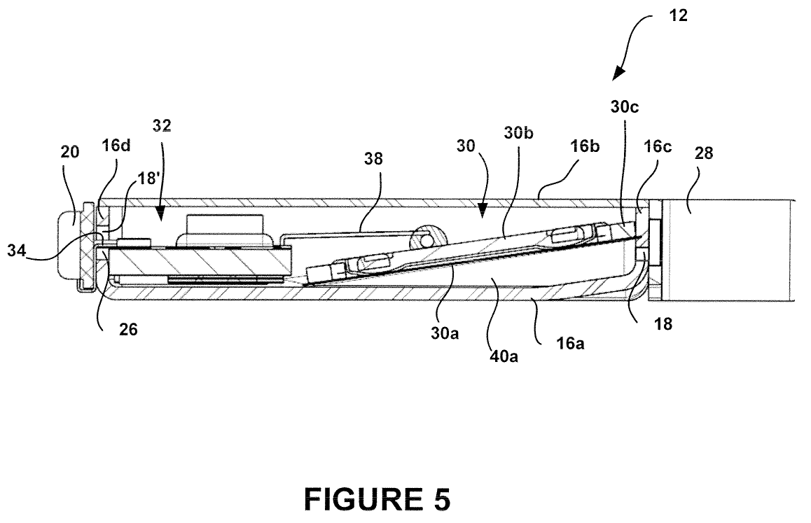

FIG. 5 illustrates a cross-sectional view of an exemplary embodiment of the microphone 12. The motor assembly 30 is disposed within the housing 6 such that one side of the motor assembly 30 is fixedly attached to the inner surface of the front portion 16c and the opposed side of the motor assembly 30 is fixedly attached to the inner surface of the cover 16a. The enclosed area 40a, formed by the motor assembly 30 wherein the diaphragm 30a is faced downward to the inner surface of the cover 16a and the inner surface of the front portion 16c, constitutes a front volume 40a. The sound port 18 formed on the front portion 16c communicates with the front volume 40a to allow signals to enter the microphone 12. The circuit assembly 32 is positioned adjacent the opposed side of the motor assembly 30 near where it attaches to the inner surface of the base 16a and itself is adjacent to the inner surface of the base 16a. The circuit assembly 32 is attached within the housing to the inner surface of the rear portion 16d. A ribbon wire 34 for grounding radio frequency interference (RFI) and a plurality of connecting wires (not shown) for providing input/output/power extend through a hole 18′ formed on the rear portion 16d of the housing 16. The wires, in turn, couple to the external terminal(s) 20. As depicted in FIG. 5, instead of stacking the motor assembly 30 either over or under the circuit assembly 32 as is typically done, the motor assembly 30 is arranged in what can be described as series or side-by-side relationship with the circuit assembly 32. This arrangement advantageously reduces the overall height of the microphone 12, for example, by about 5% to about 90% of a conventional microphone. More particularly, the microphone 12 may have a height of from about 0.5 to 1 mm. The cover 16a of the microphone 12 may further be formed with a tapered portion to allow deep fitting of the microphone and/or a corresponding exterior housing therefore into the ear canal and also to allow fitting into smaller listening devices. The outside microphone 6 as depicted in FIG. 1 may be assembled the same way as the microphone 12 used for the transducer monitor system 10 or any other listening devices.

The size, thickness and length, for example, of a microphone 12 may be further reduced. The housing 16 may be formed to include an aperture. The aperture may be formed in a single wall of the housing such as 16a, 16b or 16d, or may be formed at the intersection of two walls. For example, an aperture may be formed where wall 16a intersects wall 16d. The circuit board portion of the circuit assembly 32 may be positioned and secured within the opening, and thus the interior size of the housing 16 and correspondingly the exterior size of the housing may be reduced. Alternatively, the opening may be formed at the intersection of the wall 16b and the wall 16d, and the circuit board portion of the circuit assembly 32 positioned and secured within that opening. In this later arrangement, it will be appreciated, that the circuit assembly 32 is positioned under motor assembly 30, but not in the stacked arrangement of a typical electret microphone. Forming the housing to include a portion of the circuit assembly 32 advantageously allows for the connecting wires to be reduced or eliminated, as the external terminal(s) may be formed directly on the circuit assembly 32 and any connecting wires formed as traces on or within the circuit board portion of the circuit assembly 32. Providing the connecting wires as traces on or within the circuit board portion of the circuit assembly 32 furthermore significantly reduces manufacturing/assembly complexity. Still further reductions in housing size may be achieved by forming all or a portion of the frame member of the motor assembly 30 into the one or more of the housing walls. The resulting microphone is highly compact with simplified manufacturing.

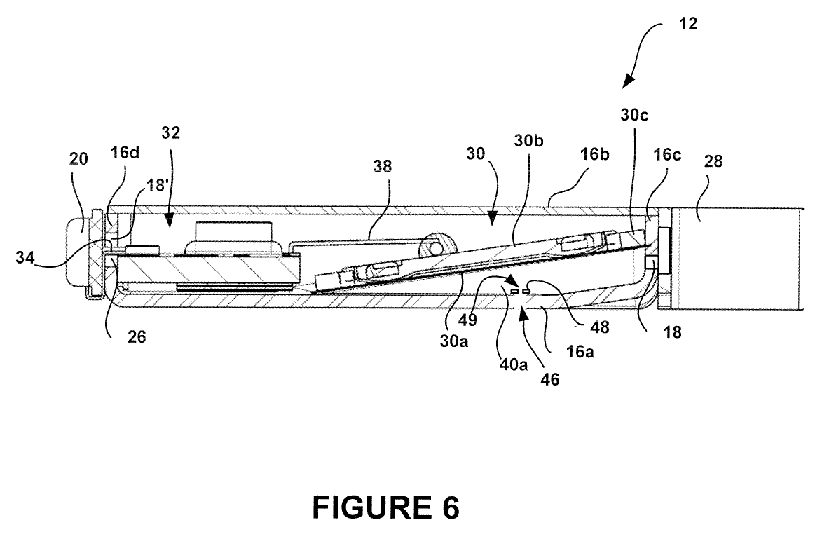

FIG. 6 illustrates a cross-sectional view of another embodiment of the microphone 12. A vent 46 may be formed on the cover 16a of the housing. The vent 46 may have a dimension of about 0.008 inches and may be formed by any suitable technique. The ultimate size and location of the vent 46 may depend upon the application. A member 48 with a vent 49 of a size different than the vent 46, e.g., smaller, of the cover 16a may overlap the vent 46 and can be formed by any suitable technique. The vent 49 may have a dimension of about 0.001 inches when the vent 46 has the about 0.008 inches dimension. Alternatively the vent 46 of the cover 16a may include a plurality of smaller holes. Preferably the plurality of small holes has an acoustic resistance, with the acoustic resistance being chosen to be substantially equivalent to the acoustic resistance of a single hole acoustic vent. The member 48 is made of stainless steel. The use of other types of material for the housing is possible. The vents 46, 49 facilitate the pressure equalization between the front volume 40a and the surrounding outside the microphone housing 16. An optional damping member may be provided to cover the first vent 46 or the second 49 and preventing debris from clogging the vents 46, 49. The damping member may further modify the acoustic characteristics of the microphone 12.

All references, including publications, patent applications, and patents, cited herein are hereby incorporated by reference to the same extend as if each reference were individually and specifically indicated to be incorporated by reference and were set forth in its entirety herein.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone assembly comprising:
a housing, the housing having a top housing and a bottom housing defining a volume;
a motor assembly, the motor assembly having a movable diaphragm and a backplate opposed to the movable diaphragm; and
a circuit assembly, the circuit assembly including a connecting lead for making contact with the diaphragm or a backplate; wherein the circuit assembly and motor assembly are serially arranged in a non-stacked arrangement of the circuit assembly and motor assembly.

2. The microphone assembly of claim 1, wherein the circuit assembly is fixedly attached to the inner surface of the bottom housing.

3. The microphone assembly of claim 1, wherein an opening is formed on the bottom housing or the top housing and the circuit assembly extends into the opening and forms a portion of the housing.

4. The microphone assembly of claim 1, the motor assembly comprising a first end and a second end spaced apart by a central portion; wherein a portion of the first and second ends fixedly attach to an inner surface of the bottom housing.

5. The microphone assembly of claim 1, wherein the motor assembly divides the volume into a front volume and a back volume.

6. The microphone assembly of claim 5, wherein a sound port is formed on the bottom housing or the top housing communicating with the front volume, the sound port allows the acoustic signal to enter the microphone assembly.

7. The microphone assembly of claim 5, wherein a sound tube is acoustically coupled to the sound port.

8. The microphone assembly of claim 5, wherein a vent is formed on the bottom housing or the top housing, the vent communicating the front volume with the surrounding.

9. The microphone assembly of claim 8, comprising a member having a smaller vent, the smaller vent overlapping the vent.

10. A system comprising at least one microphone assembly, the microphone assembly comprising:
a housing, the housing having a top housing and a bottom housing defining a volume; wherein a portion of the bottom housing or the top housing is tapered;
a motor assembly and a circuit assembly, the circuit assembly including a connecting lead for making contact with the diaphragm or a backplate; wherein the circuit assembly and motor assembly are serially arranged in a non-stacked arrangement of the circuit assembly and motor assembly.

11. The system of claim 10, further comprising an opening formed on the bottom housing or the top housing, the circuit assembly extends into the opening and forms a portion of the housing.

12. The system of claim 10, wherein the motor assembly divides the volume into a front volume and a back volume.

13. The system of claim 10, comprising a sound port formed adjacent the tapered portion of the bottom housing or the top housing communicating with the front volume and allows an acoustic signal to enter the microphone assembly.

14. The system of claim 13, further comprising a sound tube, the sound tube having a passageway communicating with the sound port is fixedly attached to the microphone housing.

15. The system of claim 10, wherein the circuit assembly is fixedly attached to the inner surface of the bottom housing or the top housing.

16. The system of claim 10, the motor assembly comprising a first end and a second end spaced apart by a central portion; wherein a portion of the first and second ends fixedly attach to an inner surface of the bottom housing or the top housing.

17. The system of claim 10, further comprising at least one receiver assembly, wherein the receiver assembly is coupled to the microphone assembly.

18. The system of claim 17, the receiver assembly comprising a housing, wherein the receiver housing is fixedly coupled to an un-tapered portion of the microphone housing.

19. The system of claim 18, comprising a sound port formed on the receiver housing.

20. The system of claim 19, comprising a sound tube attached to the system the sound tube defining a first and a second passageway, the first passageway communicating with the microphone sound port and the second passageway communicating with the receiver sound port.

21. The system of claim 18, further comprising a sound tube, the sound tube attached to the receiver housing, such that a passageway of the sound tube communicates with the sound port.

22. The microphone assembly of claim 10, comprising a vent formed on volume with the surrounding.

23. The microphone assembly of claim 22, comprising a member having a smaller vent overlaps the vent.

24. A listening device comprising:
an outside microphone for receiving acoustic energy and converting the acoustic energy into electrical signals;
a processing circuit system electrically coupled to the outside microphone; and
a transducer monitor system, the transducer monitor system comprising at least one inside microphone, the inside microphone having a motor assembly and a circuit assembly;
wherein the circuit assembly and motor assembly are serially arranged in a non-stacked arrangement of the circuit assembly and motor assembly.

25. The listening device of claim 24, the transducer monitor system further comprising a receiver assembly, the receiver assembly being electrically coupled to the processing circuit system.

26. The listening device of claim 24, wherein the processing circuit system is selected from a group comprising a digital processing system, a sound measurement system, a filter system, a control signal system, a converter, a sound pressure level adjusting system, or combination thereof.

27. The listening device of claim 24, the outside microphone comprising a motor assembly and a circuit assembly, wherein the outside microphone circuit assembly and motor assembly are serially arranged in a non-stacked arrangement of the outside microphone circuit assembly and motor assembly.

28. A method of making a microphone assembly comprising:
providing a housing, the housing including a top housing and a bottom housing;
disposing a transducer including a motor assembly and a circuit assembly within the housing; and
placing the circuit assembly in series with the motor assembly in a non-stacked arrangement of the circuit assembly and the motor assembly.

29. The method of claim 27, comprising coupling the circuit assembly to the inner surface of the bottom housing.

30. The method of claim 27, comprising forming an opening on the bottom housing or top housing and extending the circuit assembly into the opening.

31. The method of claim 27, the motor assembly including a first end and a second end spaced apart by a central portion; the method comprising coupling a portion of the first and second ends to the inner surface of the bottom housing.

32. The method of claim 27, comprising providing a sound port on the bottom housing or the top housing, the sound port allowing the acoustic signal to enter the microphone assembly.

33. The method of claim 27, coupling a sound tube to the sound port.

34. The method of claim 27, forming a vent on the bottom housing or the top housing.

35. The method of claim 27, providing a member having a smaller vent and overlapping the smaller vent of the member over the vent of the bottom housing or the top housing.

36. A monitor system comprising a microphone assembly and a receiver assembly coupled together, the microphone assembly comprising:
a housing, the housing having a top housing and a bottom housing defining a volume; wherein a portion of the bottom housing or the top housing is tapered;
a motor assembly and a circuit assembly, the circuit assembly including a connecting lead for making contact with the diaphragm or a backplate; wherein the circuit assembly and motor assembly are serially arranged in a non-stacked arrangement of the circuit assembly and motor assembly.

37. The system of claim 36, further comprising an opening formed on the bottom housing or the top housing, the circuit assembly extends into the opening and forms a portion of the housing.

38. The system of claim 36, wherein the motor assembly divides the volume into a front volume and a back volume.

39. The system of claim 36, comprising a sound port formed adjacent the tapered portion of the bottom housing or the top housing communicating with the front volume and allows an acoustic signal to enter the microphone assembly.

40. The system of claim 39, further comprising a sound tube, the sound tube having a passageway communicating with the sound port is fixedly attached to the microphone housing.

41. The system of claim 36, wherein the circuit assembly is fixedly attached to the inner surface of the bottom housing or the top housing.

42. The system of claim 36, the motor assembly comprising a first end and a second end spaced apart by a central portion; wherein a portion of the first and second ends fixedly attach to an inner surface of the bottom housing or the top housing.

43. The system of claim 36, the receiver assembly comprising a housing, wherein the receiver housing is fixedly coupled to an un-tapered portion of the microphone housing.

44. The system of claim 43, comprising a sound port formed on the receiver housing.

45. The system of claim 45, comprising a sound tube attached to the system, the sound tube defining a first and a second passageway, the first passageway communicating with the microphone sound port and the second passageway communicating with the receiver sound port.

46. The system of claim 44, further comprising a sound tube, the sound tube attached to the receiver housing such that a passageway of the sound tube communicates with the sound port.

47. The microphone assembly of claim 36, comprising a vent formed on the bottom housing or the top housing of the microphone assembly, the vent communicating the volume with the surrounding.

48. The microphone assembly of claim 22, comprising a member having a smaller vent overlaps the vent.
